(19) United States
(12) Patent Application Publication
(10) Pub. No.: US 2007/0164865 A1
(43) Pub. Date: Jul. 19, 2007

(54) SECURITY SENSOR SYSTEM

(76) Inventors: Gerald Giasson, Sherwood, OR (US); Clinton Chan, Covina, CA (US); Jon DeLuche, Pasadena, CA (US); Armando Benavides, Los Angeles, CA (US)

Correspondence Address: SHELDON MAK ROSE & ANDERSON PC, 100 East Corson Street, Third Floor, PASADENA, CA, 91103-3842, US

(21) Appl. No.: 11/556,686

(22) Filed: Nov. 3, 2006

Related U.S. Application Data
(60) Provisional application No. 60/733,940, filed on Nov. 4, 2005.

(51) Int. Cl. G08B 13/14

(52) U.S. Cl. 340/572.4

(57) ABSTRACT

A security system suitable for retail establishments carrying articles comprises tags for affixing to the articles, the tag being capable of generating a responsive microwave signal in response to a microwave detection signal; and at least one transceiver for generating the microwave detection signal and for receiving the responsive microwave signal.

### CROSS-REFERENCE TO RELATED APPLICATION

The present application claims the benefit of U.S. Provisional Patent Application No. 60/733,940 titled “Security Sensor System,” filed Nov. 4, 2005, the contents of which are incorporated in this disclosure by reference in their entirety.

### BACKGROUND

Theft of merchandise is often a concern for retailers. To counter theft, retailers employ a variety of security systems that make it more difficult to remove an item from a store without proper deactivation at the time of payment. Among these devices are the common metallic tag and sensor stands, microwave detection devices and radio frequency identification (RFID) tags and sensors.

Advantageously, the common metallic tag and sensor stands are inexpensive to implement. Disadvantageously, the gaps between the sensor stands and the entrance can allow thieves to bypass the stand. Further, the height of the stands can also allow thieves to pass items over the sensor stands without setting off an alarm. Additionally, the shape of the metallic tags allows them to be passed through the sensor stands at an angle that will not set off the alarm. Also, the metallic tags often are not deactivated at checkout leading to numerous false positive alarms.

Advantageously, RFID tag systems can hold information about the item to which it is attached, such as the price, inventory control and other information useful to retail stores. Disadvantageously, however, RFID tags are expensive and current RFID scanners have only a seventy percent margin of accuracy when retrieving information on the tag. Also, there are privacy concerns because RFID are not deactivated at checkout and can be traced after the customer has left the retail establishment.

Therefore there exists a need for a retail security system that is not associated with these disadvantages.

### SUMMARY

A system suitable for detecting an article such as in a retail store comprises a tag for affixing to the article, the tag being capable of generating a responsive microwave signal in response to a microwave detection signal; and at least one transceiver for generating the microwave detection signal and for receiving the responsive microwave signal. Preferably, the detection signal comprises at least one burst of no more than 0.10 seconds duration with the interval between bursts when there is more than one burst being at least 0.10 seconds.

Optionally the system comprises a processing unit for generating a transmit code; and the transceiver comprises: a) a first transmitter communicatively coupled to the processing unit for transmitting the first detection signal with the transmit code; b) a second transmitter communicatively coupled to the processing unit for transmitting the second detection signal with the transmit code; c) a receiver for receiving the responsive microwave signal from the tag; and d) an antenna electrically coupled to the first transmitter and the second transmitter and the receiver.

Optionally the system also comprises a) an alarm communicatively coupled to the processing unit; b) at least one clock communicatively coupled to the processing unit, the first transmitter, the second transmitter and the receiver to time the transmission of signals and reception of signals to and from the tag; and c) at least one presence detector communicatively coupled to the processor for causing transmission of the detection signals by the transmitters.

The alarm, processing unit, first and second transmitters, antenna, receiver and clock can be disposed in a single housing.

Preferably the two transceivers are capable of transmitting a modulated microwave frequency that does not interfere with medical devices. Also, preferably the first transmitter transmits the transmit code on a first frequency and the second transmitter transmits the transmit code on a second frequency different from the first frequency.

The presence detector can be selected from the group consisting of proximity, infrared, pressure, optical, motion, light, temperature, magnetic fields, gravity, vibration, electrical fields, sound and biological sensors, and two or more thereof. Motion detectors are preferred.

A preferred tag comprises: a) a substrate having first and second sides; b) a first dipole antenna fixed at the first side and having two poles, each pole having an end and a base, the ends of the first dipole antenna being electrically connected; and c) a second dipole antenna fixed at the second side and having two poles, each pole having an end and a base, the ends of the second dipole antenna being electrically connected. The first and seconds antennas optionally are connected by a bridge rectifier so that when the first dipole antenna receives first and second signals having first and second frequencies respectively, the first and second frequencies being different, the second dipole antenna generates a signal whose frequency equals the sum of the first and second frequencies. The bridge rectifier can be a passive semiconductor diode full wave bridge rectifier for summing microwave frequencies. Preferably the first and second frequencies are different by at least about 1% of each other and are different by no more than about 10% of each other. In a preferred version of the invention, the first dipole antenna is tuned to a frequency of from about 2403.55 MHz to 2478.00 MHz and the second dipole antenna is tuned to a frequency of from about 4807.10 MHz to 4956.00 MHz.

The first dipole antenna shape and the second dipole antenna shape can independently selected from the group consisting of spiral, helical, square, dipole, whip, biconical, collinear, crossed field, directional, isotropic, log periodic, microstrip, omnidirectional, planar array, rhombic and yagi, with spiral being the preferred shape.

When the system is used for detecting the unauthorized removal of articles from a facility, the tags are affixed to the articles, and at least one transceiver generates a coded detection signal at an exit of the facility, and receives the responsive microwave signal. At least one presence detector for detecting a person at the exit serves to cause the transceiver to generate the detection signal. The alarm, which is electrically connected to the transceiver, provides a notice that one of the tags is at the exit.

Optionally, at least some of the tags can have information relating to the article to which the tag is affixed, so that the responsive microwave signal carries the information from the tag to the transceiver, and the transceiver is capable of detecting the information.

### BRIEF DESCRIPTION OF THE DRAWINGS

These and other features, aspects and advantages of the present invention will become better understood with regard to the following description, appended claims, and accompanying figure where:

FIG. 1 is a block diagram of a retail store entrance and security system;

FIG. 2 is a schematic diagram of one side of an antenna used with the security system;

FIG. 3 is a schematic diagram of the opposite side of an antenna used with the security system; and

FIG. 4 is a block diagram of the security system.

### DESCRIPTION

According to one embodiment of the present invention, there is provided a retail article surveillance system where the tags are placed in all the articles of the retail establishment. According to another embodiment of the present invention, there is provided a device for a retail article surveillance system where the tags are placed in all articles of the retail establishment. In one embodiment, the device comprises a retail article surveillance system according to the present invention. According to another embodiment of the present invention, there is provided a method for retail article surveillance where the tags are placed in all articles of the retail establishment. In one embodiment, the method comprises, providing a device according to the present invention. The system, device, and method will now be disclosed in detail.

All dimensions specified in this disclosure are by way of example only and are not intended to be limiting. Further, the proportions shown in the figures are not necessarily to scale. As will be understood by those with skill in the art with reference to this disclosure, the actual dimensions of any device or part of a device disclosed in this disclosure will be determined by its intended use. Additionally, numerous specific details are set forth in order to provide a thorough understanding of the invention. One skilled in the art, however, would recognize that the invention may be practiced without these specific details. In other instances, well known methods, procedures, and/or components have not been described in detail so as not to unnecessarily obscure aspects of the invention.

As used in this disclosure, except where the context requires otherwise, the term “comprise” and variations of the term, such as “comprising”, “comprises” and “comprised” are not intended to exclude other additives, components, integers or steps.

In the following description, certain terminology is used to describe certain features of one or more embodiments of the invention. The term transceiver refers to a device which combines both transmission and reception capabilities within a single housing. The term microwave frequency refers to electromagnetic waves with frequencies between 300 MHz and 300 GHz. The term “one or more” is synonymous with “at least one” when referring to an element of the invention.

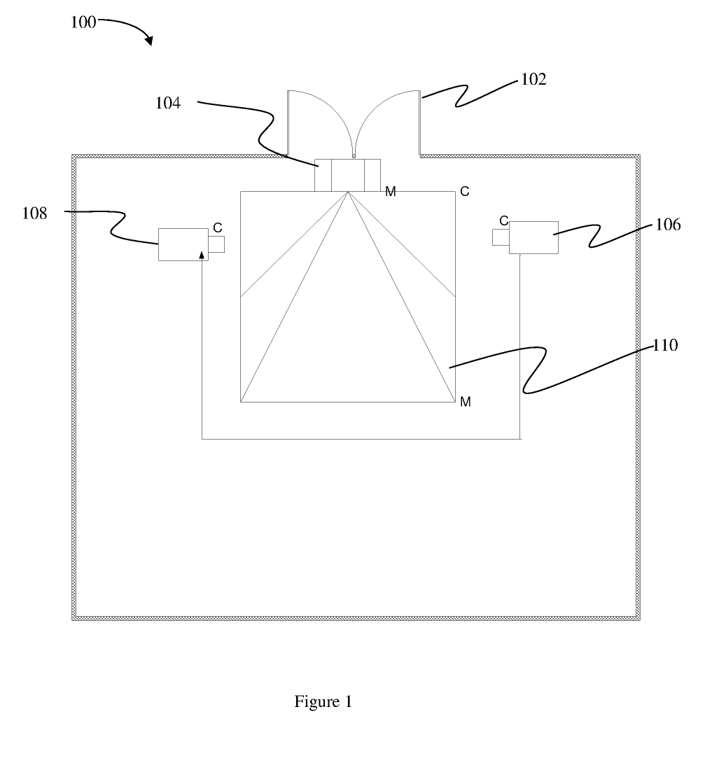

Referring now to FIG. 1, there is shown a block diagram of a retail security system 100 according to one embodiment of the present invention. As can be seen, the system comprises a transceiver unit 104 mounted over the store entrance 102. The transceiver unit 104 is communicatively coupled to the presence detection devices 106 and 108. The presence detection devices 106 and 108 define the effective transmission/reception range 110 of the system.

In one embodiment, a transceiver unit 104 is placed in the entrance of a retail store. The presence detection devices 106 and 108 are communicatively coupled to the transceiver unit 104. The presence detection devices 106 and 108 define an effective transmission/reception range of the retail security system 100. The presence detection devices can be selected from the group consisting of proximity, infrared, pressure, optical, motion, light, temperature, magnetic fields, gravity, vibration, electrical fields, sound and biological sensors, and combinations of two or more of these sensors. In a preferred embodiment, the presence detection devices are motion detectors.

In one embodiment, the tags are placed in all articles of the retail establishment. The transceiver units are placed at the entrances and the exits of the store. The transceiver units broadcast microwave transmissions covering the entrances and the exits when the presence detectors determine that an object is within range of the transceiver unit. Any article that has a tag that is not de-activated responds to the transmission. The transceiver unit compares a coded transmitted signal with the signal re-transmitted by the tag at a different frequency and compares the intelligence contained within the transmissions. If there is a threshold match the system triggers an alarm notifying store personnel that a tag that has not been deactivated has passed through the entrance or the exit.

In a preferred embodiment, the transceiver units will transmit a plurality of coded signals until a threshold match is reached reducing the possibility of false alarms.

In another embodiment, the tags have information relating to the article to which the tag is affixed, and the responsive microwave signal carries the information from the tag to the transceiver, and the transceiver is capable of detecting the information.

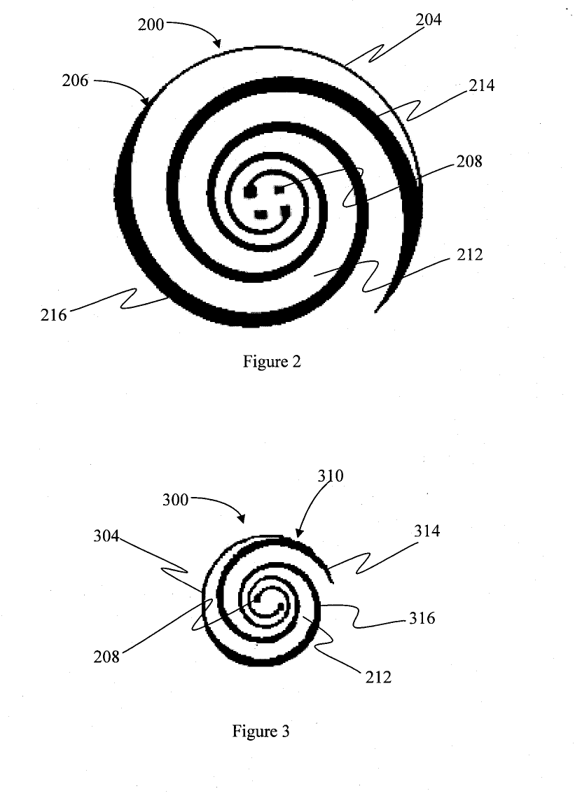

Referring now to FIGS. 2 and 3, there is shown a schematic diagram of a retail article tag 200 used with the retail security system 100. The tag 200 is generally shaped as a disc with opposed sides and comprises an electrically neutral substrate 212. A first side of the tag 200 is shown in FIG. 2 and an opposed second side is shown in FIG. 3. As can be seen, a first antenna 206 at, and preferably on, the first side can be a spiral dipole type antenna. The first antenna 206 is comprised of two helical poles 214 and 216 that are affixed to an electrically neutral substrate 212. A VDC (voltage direct current) return 204 is electrically connected to each end of the dipoles 214 and 216. A bridge rectifier 208 is electrically connected to the base of each dipole 214 and 216.

Referring now to FIG. 3, a second antenna 310, which can be a spiral antenna with two poles 314 and 316 is at, and preferably on, the second side of the tag 200. The second antenna 310 is affixed to the electrically neutral substrate 212. A VDC return 304 is electrically connected to each pole 314 and 316 of the second antenna 310. The bridge rectifier 208 is electrically connected to the first antenna 206 and the second antenna 310 through the electrically neutral substrate 212. In a particularly preferred embodiment, the second antenna 310 is a passive, dual dipole, double helix configuration antenna.

In a preferred embodiment, the first antenna 206 is a passive, dual dipole, spiral antenna with the first antenna 206 tuned to receive a transmitted first and second frequencies and the second antenna 310 tuned to transmit a third frequency. In a preferred embodiment, the first dipole antenna 206 is tuned to receive two similar microwave frequencies and the second dipole antenna 310 is tuned to transmit the sum of the received transmitted microwave frequencies. In a particularly preferred embodiment, the bridge rectifier 208 is a passive semiconductor diode full wave bridge rectifier for summing the two similar received microwave frequencies. Preferably the transmitted frequencies are from about 300 MHz to about 150 GHz, and more preferably from about 2.3 GHz to about 5.8 GHz because in this range, which is comparable to the ranges used for portable phones, interference with medical devices such as pacemakers is unlikely. Most preferably the frequencies are from about 2403.55 MHz to 2478.0 MHz.

Preferably the two frequencies differ by less than about 10% and more preferably less than about 5%, and preferably by at least about 1%. The greater the difference, the more likely there will be interference from other devices, and if the difference is too small, summation may not occur.

For safety, preferably the transceivers only intermittently transmit. Preferably the transmission is a burst of at least about 10 milliseconds and up to about 500 milliseconds.

In another embodiment, the antenna may have multiple shapes including: spiral, helical, square, dipole, whip, biconical, collinear, crossed field, directional, isotropic, log periodic, microstrip, omnidirectional, planar array, rhombic, yagi, and others known in the art.

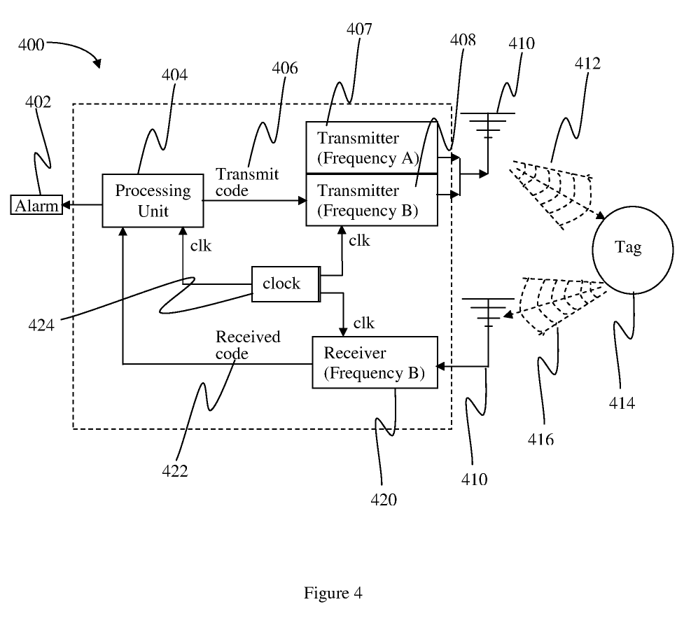

Referring now to FIG. 4, there is shown a block diagram of a retail security system device 400. As can be seen, an alarm 402 is communicatively coupled to a processing unit 404. The processing unit 404 is electrically connected to a first transmitter 407 and to a second transmitter 408. The first transmitter 407 and the second transmitter 408 receive a transmit code 406 from the processing unit 404. The first transmitter 407 and the second transmitter 408 are electrically coupled to a transmission/reception antenna 410 for sending the transmit code 406. The transmission/reception antenna 410 is communicatively coupled to a tag 414 by transmitting a signal 412 to tag 414. The tag 414 is communicatively coupled to the transmission/reception antenna 410 that receives the signal 416 from the tag 414. The transmission/reception antenna 410 is electrically coupled to a receiver 420 for receiving the signal 416 from the tag 414 with the transmit code 406. The receiver is electrically coupled to the processing unit 404 for sending the received code 422 to the processing unit 404. A clock 424 is communicatively coupled to the processing unit 404, the first transmitter 407, the second transmitter 408 and the receiver 420 to time the transmission and reception of the signals 412 and 416.

In a preferred embodiment, the retail security system transceiver unit and alarm are in a single housing. In a particularly preferred embodiment, the transceiver unit uses modulated microwave frequencies comprising digital codes that do not interfere with medical devices or other common electronics, such as, for example, pace makers, hearing aides, cellular telephones, etc. In another particularly preferred embodiment, the transceiver unit uses a single clock for both the transmitter and receiver.

According to another embodiment of the present invention, there is provided a method for retail security. In one embodiment, the method comprises, first, providing a system as described above. Then, the transceivers are placed so that they are capable of transmitting signals to and receiving signals from the tags when the tags are proximate to the entrances/exits; security tags are placed in all the articles in the store; and the presence detectors are placed at the exits/entrances. When a person enters the presence detectors, the transceiver transmits an encoded microwave signal on two separate frequencies. Next, the tag receives the encoded microwave signal and sums the two separate frequencies together. Then, the tag retransmits the summed frequency and the encoded microwave signal back to the transceiver. Next, a receiver in the retail security device removes the summed frequency from the encoded microwave signal. Then, the encoded signal is sent back to the processing unit. Next, the processing unit compares the received code with the transmitted code. Then, if the codes are matched the processing unit sets off an alarm notifying store personnel that an active tag is in the detection area.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled in the art will appreciate that various adaptations and modifications of the just described embodiments can be configured without departing from the scope and spirit of the invention. For example, instead of using a combined transceiver unit, it is possible to use separate transmitters and receivers. Therefore, it is to be understood that, within the scope of the appended claims, the invention may be practiced other than as specifically described herein.

What is claimed is:

1. A system suitable for detecting an article comprising:
a) a tag for affixing to the article, the tag being capable of generating a responsive microwave signal in response to a microwave detection signal; and
b) at least one transceiver for generating the microwave detection signal and for receiving the responsive microwave signal.

2. The system of claim 1, wherein the detection signal comprises at least one burst of no more than 0.10 seconds duration with the interval between bursts when there is more than one burst being at least 0.10 seconds.

3. The system of claim 1 comprising two transceivers for generating first and second microwave detection signals having different frequencies, and the responsive microwave signal has a frequency equal to the sum of the frequencies of the first and second microwave detection signals.

4. The system of claim 1, comprising a processing unit for generating a transmit code; and wherein the transceiver comprises
a) a first transmitter communicatively coupled to the processing unit for transmitting the first detection signal with the transmit code;
b) a second transmitter communicatively coupled to the processing unit for transmitting the second detection signal with the transmit code;
c) a receiver for receiving the responsive microwave signal from the tag; and
d) an antenna electrically coupled to the first transmitter and the second transmitter and the receiver.

5. The system of claim 1 further comprising:
a) an alarm communicatively coupled to the processing unit;
b) a processing unit for generating the transmit code and communicatively coupled to the alarm;
c) at least one clock communicatively coupled to the processing unit, the first transmitter, the second transmitter and the receiver to time the transmission of signals and reception of signals to and from the tag; and
d) at least one presence detector communicatively coupled to the processor for causing transmission of the detection signals by the transmitters.

6. The system of claim 4, wherein the alarm, processing unit, first and second transmitters, antenna, receiver and clock are disposed in a single housing.

7. The system of claim 3, wherein the two transceivers are capable of transmitting a modulated microwave frequency that does not interfere with medical devices.

8. The system of claim 4, wherein the first transmitter transmits the transmit code on a first frequency and the second transmitter transmits the transmit code on a second frequency different from the first frequency.

9. The system of claim 5 wherein the presence detector is selected from the group consisting of proximity, infrared, pressure, optical, motion, light, temperature, magnetic fields, gravity, vibration, electrical fields, sound and biological sensors, and two or more therof.

10. The system of claim 9, wherein the presence detector is a motion detector.

11. A tag comprising:
a) a substrate having first and second sides;
b) a first dipole antenna fixed at the first side and having two poles, each pole having an end and a base, the ends of the first dipole antenna being electrically connected; and
c) a second dipole antenna fixed at the second side and having two poles, each pole having an end and a base, the ends of the second dipole antenna being electrically connected.

12. The tag of claim 11, wherein the first and seconds antennas are connected by a bridge rectifier so that when the first dipole antenna receives first and second signals having first and second frequencies respectively, the first and second frequencies being different, the second dipole antenna generates a signal whose frequency equals the sum of the first and second frequencies.

13. The system of claim 11, wherein the first and second frequencies are different by at least about 1% of each other.

14. The system of claim 11, wherein the first and second frequencies are different by no more than about 10% of each other.

15. The system of claim 11, wherein the first and second frequencies are different by about 1% to about 10% of each other.

16. The tag of claim 11, wherein the first dipole antenna is tuned to a frequency of from about 2403.55 MHz to 2478.00 MHz.

17. The tag of claim 11, wherein the second dipole antenna is tuned to a frequency of from about 4807.10 MHz to 4956.00 MHz.

18. The tag of claim 11, wherein the first dipole antenna shape and the second dipole antenna shape are independently selected from the group consisting of spiral, helical, square, dipole, whip, biconical, collinear, crossed field, directional, isotropic, log periodic, microstrip, omnidirectional, planar array, rhombic and yagi.

19. The tag of claim 18, wherein the first diple antenna shape and the second dipole antenna shape are spiral.

20. The tag of claim 11, wherein the bridge rectifier is a passive semiconductor diode full wave bridge rectifier for summing microwave frequencies.

21. A system suitable for detecting the unauthorized removal of articles from a facility comprising:
a) tags for affixing to the articles, each tag being capable of generating a responsive microwave signal in response to at least one microwave detection signal;
b) at least one transceiver for generating the detection signal at an exit of the facility and for receiving the responsive microwave signal; and
c) at least one presence detector for detecting a person at the exit and then causing the transceiver to generate the detection signal.

22. The system of claim 21 comprising in addition an alarm electrically connected to the transceiver for providing a notice that one of the tags is at the exit.

23. The system of claim 22, wherein the transceiver and presence detector and alarm are in the same housing.

24. The system of claim 21, wherein the transceiver and presence detector are in the same housing.

25. The system of claim 21, wherein the transceiver provides a transmit code that is carried by the detection signal.

26. The system of claim 1, wherein at least some of the tags have information relating to the article to which the tag is affixed, and the responsive microwave signal carries the information from the tag to the transceiver, and the transceiver is capable of detecting the information.

27. A method for article surveillance in a retail store, the method comprising the steps of:
a) selecting the system of claim 1; and
b) placing the tags on articles sold by the retail store.

28. The method of claim 27 comprising the additional steps of:
a) placing the transceiver to generate a detection signal that the tags, when proximate to at least one exit of the retail store, generates a responsive signal detectable by the transceiver; and
b) placing a presence detector to activate the transceiver proximate to the exit.

29. The method of claim 28 comprising the additional steps of:
a) activating the transceiver when a person is detected by the presence detector;
b) transmitting at least one coded signal on two different frequencies from the transceiver to the tag, wherein the tag generates the responsive microwave signal at a frequency equal to the sum of the two transmitted signals back to the transceiver, the responsive microwave signal including the code; and
c) activating an alarm code in the responsive microwave signal is the same as the code of the transmitted signal.
